(19) United States
(12) Patent Application Publication
(10) Pub. No.: US 2023/0401328 A1
(43) Pub. Date: Dec. 14, 2023

(54) PROTECTING SENSITIVE DATA DUMP INFORMATION

(71) Applicant: INTERNATIONAL BUSINESS MACHINES CORPORATION, Armonk, NY (US)

(72) Inventors: Xi Bo Zhu, Beijing (CN); Bo Chen Zhu, Xi'an (CN); Peng Hui Jiang, Beijing (CN); Cheng Fang Wang, Beijing (CN)

(21) Appl. No.: 17/839,346

(22) Filed: Jun. 13, 2022

(51) Int. Cl. G06F 21/62; G06F 21/60

(52) U.S. Cl. CPC G06F 21/6218; G06F 21/602

(57) ABSTRACT

A method and implementing system protects sensitive data dump information. The method comprises using a processor receiving a dump file (DF) associated with an application. The method further comprises allocating user classification profiles defining security access levels to different regions of the DF and encrypting a first encrypted region that is a proper subset of the different regions using a first encryption key associated with a first user classification profile of the user classification profiles to produce an encrypted DF (EDF). The method further comprises determining a first user to be a member of the first user classification profile, and providing access to the EDF and a first decryption key useable to decrypt the first encrypted region to the first user.

### BACKGROUND

Disclosed herein is a system and related method for protecting sensitive data dump information. In particular, the use of encryption and decryption are provided for allowing user access to portions of the data dump that they are allowed to view.

Computer-based access controls are called logical access controls (LACs). These are protection mechanisms that limit users' access to information to only what is appropriate for them. Logical access controls are often built into the operating system, or can be part of the logic of application programs or major utilities, such as database management systems. They may also be implemented in add-on security packages that are installed into an operating system; such packages are available for a variety of systems, including PCs and mainframes. Further, logical access controls might be present in specialized components that regulate communications between computers and networks.

To be effective, access control must allow management to adopt the principle of least possible privilege for those resources that are deemed to be highly sensitive. This principle says that access to these resources is controlled in such a way that permission to use them is restricted to just those people whose normal duties require their use. Any unusual use of the resource should be approved by an administrator or manager, as well as the owner of the resource.

By way of example only, the Resource Access Control Facility or RACF® is an example of an LAC which provides the tools to help an installation manage access to critical resources. Any security mechanism is only as good as the management control of the people who access the system. Access, in a computer-based environment, means the ability to do something with a computer resource (for example, use, change, or view something). Access control is the method by which this ability is explicitly enabled or restricted. It is the responsibility of the installation to see that access controls that are implemented are working the way they are supposed to work, and that variances are reported to and acted on by management. For example, RACF® provides the tools to manage user access to critical resources as an add-on software product that provides basic security for a mainframe system. Examples of other security software packages include Access Control Facility 2 (ACF2®) and Top Secret®, which are designed on the principle of “security by default”. In other words, if there is no access rule to validate against, then access is prevented. RACF® is the opposite—basically one must write an access rule to deny access to a computing resource.

RACF® protects resources by granting access only to authorized users of the protected resources. RACF® retains information about users, resources, and access authorities in special structures called profiles in its database, and it refers to these profiles when deciding which users should be permitted access to protected system resources. To help an installation accomplish access control, RACF® provides the ability to: 1) identify and authenticate users; 2) authorize users to access protected resources; 3) log and report various attempts of unauthorized access to protected resource; 4) control the means of access to resources; and 5) allow applications to use the RACF® macros. RACF® uses a user ID and a system-encrypted password to perform its user identification and verification. The user ID identifies the person to the system as an RACF® user. The password verifies the user's identity. Often controls are used to enforce a password policy, such as a minimum length, lack of repeating characters or adjacent keyboard letters, and also the use of numerics as well as letters. Popular words such as “password” or the use of the user ID are often banned.

Another important policy is the frequency of password change. If a user ID has not been used for a long time, it may be revoked and special action is needed to use it again. When someone leaves a company, there may be a special procedure that ensures that the user IDs are deleted from the system. RACF®, with its lists of users and lists of resources, allows management to delegate the authority to the owners of these entities in such a way as to maintain the separation of duties while maintaining a flexible, responsive access control strategy. The delegation mechanism in RACF® and the easy, nontechnical commands that change the relationship of a user to a resource mean that adopting the principle of least possible privilege need not be burdensome nor inflexible when unusual circumstances dictate that access permission should be changed. When an unforeseen circumstance requires a change in access privilege, the change can be made by a nontechnical person with access to a time-sharing option (TSO) terminal, and management can be alerted to review the fact that the change was made.

Major subsystems, such as the Customer Information Control System (CICS®) and Database 2 (DB2®) can use the facilities of RACF® to protect transactions and files. Much of the work to configure RACF® profiles for these subsystems is done by the CICS® and DB2® system programmers. So, it may be desirable for people in these roles to have a useful understanding of RACF® and how it relates to the software they manage.

When problems occur in the operation of a computer or applications running on them, it is desirable to determine the cause of such problems. To assist in the determination problems and to diagnose that a problem occurred in customer's environment, various documents may be collected from a customer who is using the computer or applications running thereon. These documents may be referred to as an application log, a trace file, a memory dump, a data dump, a dump file (DF), and/or a data dump file. A DF is essentially a snapshot of a customer's computer, such as an application server. The DF usually contains information about load modules of the application server and user applications, along with the memory/data areas used by the system and the user(s) of the application. As used herein, the term “application” is to be broadly construed, and may include an app, utility, library routine, driver, operating system, and any code sequence that may be executed to produce a result.

In some instances, however, the user data area of the DF might contain sensitive information, for example, client related information. In such situations, a customer may be reluctant to provide the DF to a software company for problem diagnosis since the customer may be concerned about the data exposure. The software service team must then try to recreate the problem based on the customer's description of the problem, instead of (or without) the far more helpful DF. This recreation results in greatly increased effort, and might not be able to resolve the problem that customer found.

For some customers, the software company might assign a dedicated environment to deal with their issue and to limit the number of professionals accessing these files. However, doing so still does not eliminate these potential security problems completely. Moreover, unencrypted user data might also be stolen by internal users of the customer and/or software company who have the authority to investigate the dump.

### SUMMARY

Described herein is a computer-implemented method that protects sensitive data dump information. The method comprises using a processor receiving a dump file (DF) associated with an application. The method further comprises allocating user classification profiles defining security access levels to different regions of the DF and encrypting a first encrypted region that is a proper subset of the different regions using a first encryption key associated with a first user classification profile of the user classification profiles to produce an encrypted DF (EDF). The method further comprises determining a first user to be a member of the first user classification profile, and providing access to the EDF and a first decryption key useable to decrypt the first encrypted region to the first user.

Advantageously, by encrypting sensitive portions of a dump file, a much more substantive analysis may be made of the dump file since sensitive data is protected.

In some embodiments, the EDF further comprises an unencrypted region that is viewable without any decryption key. Advantageously, this allows a person with great technical expertise, but no security clearance, to look at portions of the dump file that do not contain sensitive information. This permits a better analysis than if the sensitive data were purged from the file prior to analysis, or if the entire file is sent to someone with a security clearance, but with less technical expertise.

In some embodiments, a second encrypted region is encrypted that is different from the first encrypted region and is a proper subset of the different regions using a second encryption key associated with a second user classification profile that differs from the first user classification profile of the user classification profiles to produce the encrypted DF (EDF). The method further comprises determining a second user to be a member of the second user classification profile, and providing access to the EDF and a second decryption key useable to decrypt the second encrypted region to the second user. Advantageously, this allows for multiple levels of security having access to the dump file with similar advantages exist as described in the previous paragraph.

In some embodiments, the second encrypted region additionally uses the first encryption key for encryption, and requires the first decryption key for decryption. Advantageously, this allows for a hierarchy of security levels and thus provides greater protection for intermediate levels of security.

In some embodiments, the method further comprises creating an encryption table that associates different DF regions with different users or roles. Advantageously, this allows for an easier management of the different file regions and who has access to them.

In some embodiments the encryption element is an encryption cryptographic key, and the decryption element is a decryption cryptographic key associated with the encryption cryptographic key—these may use public and private key pairs. Advantageously, the use of public and private keys simplifies key distribution and handling.

In some embodiments, the method further comprises defining a user data classification profile that defines the different regions of the DF and their respective security classifications, and using the user data classification profile to define the different regions of the DF. Advantageously, the user data classification profile provides a clear mechanism for establishing different security levels that may be associated with different regions of the DF.

Described herein is also a system is also for protecting sensitive data dump information, comprising a memory, and a processor. The processor is configured to receive a dump file (DF) associated with an application, and allocate user classification profiles defining security access levels to different regions of the DF. The processor further encrypts a first encrypted region that is a proper subset of the different regions using a first encryption key associated with a first user classification profile of the user classification profiles to produce an encrypted DF (EDF) and determines a first user to be a member of the first user classification profile. It then provides access to the EDF and a first decryption key useable to decrypt the first encrypted region to the first user. Advantageously, by encrypting sensitive portions of a dump file, a much more substantive analysis may be made of the dump file since sensitive data is protected.

Various embodiments of the system that correspond to the various embodiments of the process described above and that have similar advantages are described herein as well.

Disclosed herein is also a computer program product for a system for protecting sensitive data dump information, the computer program product comprising one or more computer readable storage media, and program instructions collectively stored on the one or more computer readable storage media, the program instructions comprising program instructions to receive a dump file (DF) associated with an application, allocate user classification profiles defining security access levels to different regions of the DF, encrypt a first encrypted region that is a proper subset of the different regions using a first encryption key associated with a first user classification profile of the user classification profiles to produce an encrypted DF (EDF), determine a first user to be a member of the first user classification profile, and provide access to the EDF and a first decryption key useable to decrypt the first encrypted region to the first user. Advantageously, by encrypting sensitive portions of a dump file, a much more substantive analysis may be made of the dump file since sensitive data is protected.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1A is a block diagram of a data processing system (DPS) according to one or more embodiments disclosed herein.

FIG. 1B is a pictorial diagram that depicts a cloud computing environment according to an embodiment disclosed herein.

FIG. 1C is a pictorial diagram that depicts abstraction model layers according to an embodiment disclosed herein.

FIG. 2A is a block diagram that illustrates an example of a system for protecting sensitive data dump information, according to various embodiments.

FIG. 2B is a block diagram that illustrates the original dump file, the encrypted dump file, and the encrypt table file in greater detail.

FIG. 3 is a block diagram illustrating an example of the user classification profile and the user data classification profile, according to some embodiments.

FIG. 4 is a process may initially be triggered when a problem occurs or when a dump command is issued in the run product address space, according to some embodiments.

### DETAILED DESCRIPTION

The following general acronyms may be used below:

TABLE 1
General Acronyms

| | |
|---|---|
| API | application program interface |
| ARM | advanced RISC machine |
| CD- | compact disc ROM |
| ROM | |
| CMS | content management system |
| COD | capacity on demand |
| CPU | central processing unit |
| CUOD | capacity upgrade on demand |
| DPS | data processing system |
| DVD | digital versatile disk |
| EVC | expiring virtual currency (a virtual currency |
| | having an expiration date, or subject |
| | to other virtual currency usage rules; local |
| | virtual currencies with expiration dates) |
| EVCU | expiring virtual currency (units) |
| EPROM | erasable programmable read-only memory |
| FPGA | field-programmable gate arrays |
| HA | high availability |
| IaaS | infrastructure as a service |
| I/O | input/output |
| IPL | initial program load |
| ISP | Internet service provider |
| ISA | instruction-set-architecture |
| LAN | local-area network |
| LPAR | logical partition |
| PaaS | platform as a service |
| PDA | personal digital assistant |
| PLA | programmable logic arrays |
| RAM | random access memory |
| RISC | reduced instruction set computer |
| ROM | read-only memory |
| SaaS | software as a service |
| SLA | service level agreement |
| SRAM | static random-access memory |
| VCUR | virtual currency usage rules |
| WAN | wide-area network |

### Data Processing System in General

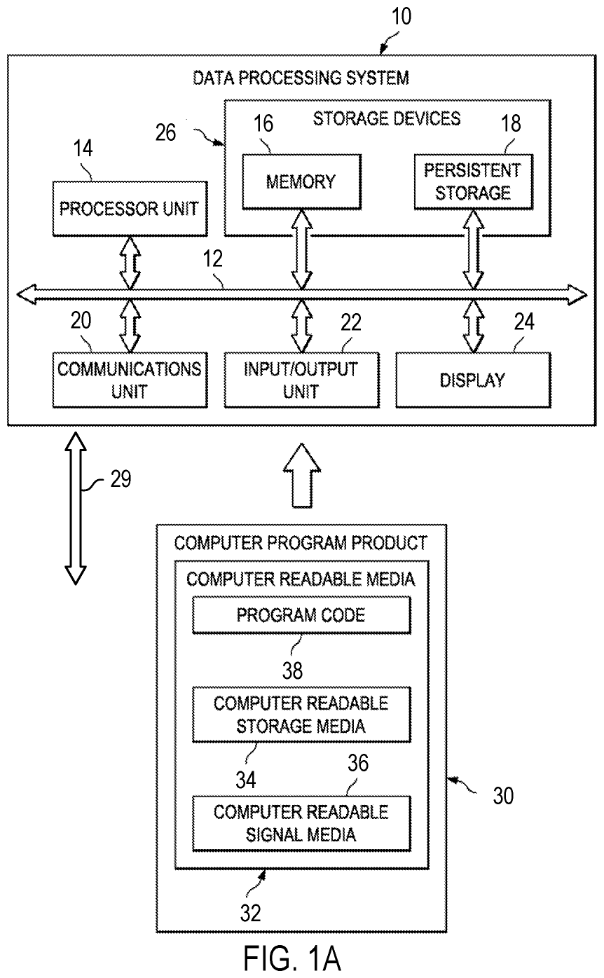

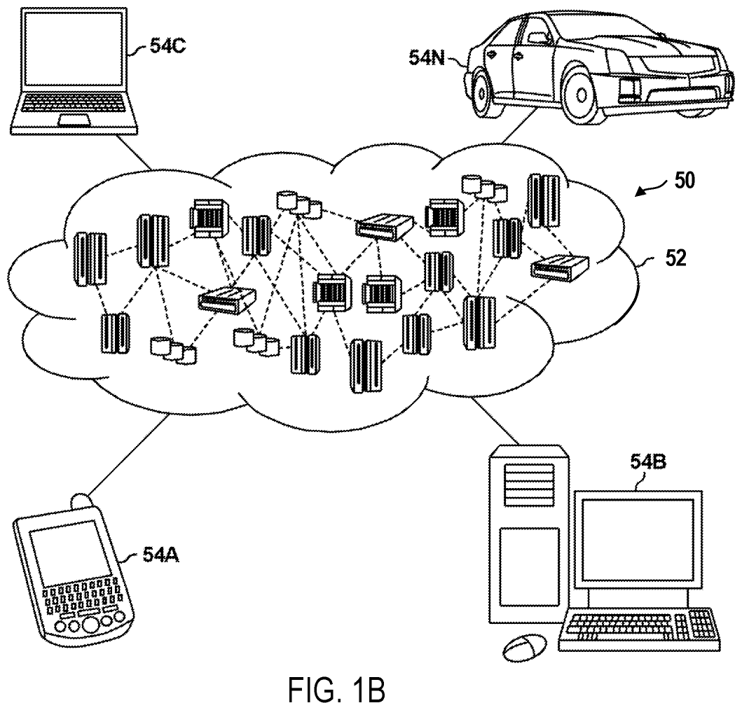

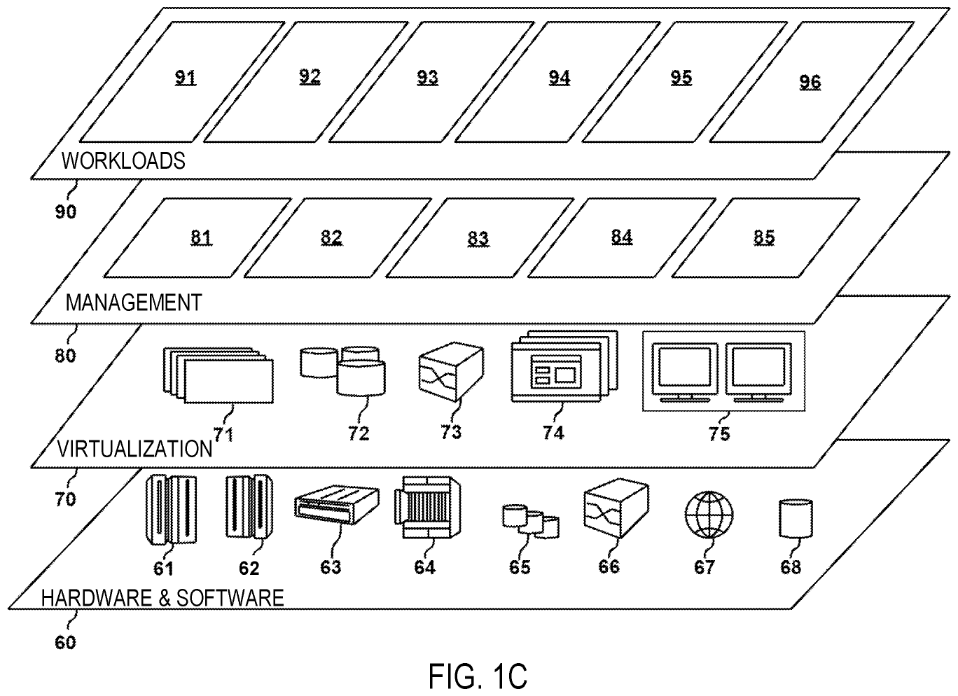

FIG. 1A is a block diagram of an example DPS according to one or more embodiments. In this illustrative example, the DPS 10 may include communications bus 12, which may provide communications between a processor unit 14, a memory 16, persistent storage 18, a communications unit 20, an I/O unit 22, and a display 24.

The processor unit 14 serves to execute instructions for software that may be loaded into the memory 16. The processor unit 14 may be a number of processors, a multi-core processor, or some other type of processor, depending on the particular implementation. A number, as used herein with reference to an item, means one or more items. Further, the processor unit 14 may be implemented using a number of heterogeneous processor systems in which a main processor is present with secondary processors on a single chip. As another illustrative example, the processor unit 14 may be a symmetric multi-processor system containing multiple processors of the same type.

The memory 16 and persistent storage 18 are examples of storage devices 26. A storage device may be any piece of hardware that is capable of storing information, such as, for example without limitation, data, program code in functional form, and/or other suitable information either on a temporary basis and/or a permanent basis. The memory 16, in these examples, may be, for example, a random access memory or any other suitable volatile or non-volatile storage device. The persistent storage 18 may take various forms depending on the particular implementation.

For example, the persistent storage 18 may contain one or more components or devices. For example, the persistent storage 18 may be a hard drive, a flash memory, a rewritable optical disk, a rewritable magnetic tape, or some combination of the above. The media used by the persistent storage 18 also may be removable. For example, a removable hard drive may be used for the persistent storage 18.

The communications unit 20 in these examples may provide for communications with other DPSs or devices. In these examples, the communications unit 20 is a network interface card. The communications unit 20 may provide communications through the use of either or both physical and wireless communications links.

The input/output unit 22 may allow for input and output of data with other devices that may be connected to the DPS 10. For example, the input/output unit 22 may provide a connection for user input through a keyboard, a mouse, and/or some other suitable input device. Further, the input/output unit 22 may send output to a printer. The display 24 may provide a mechanism to display information to a user.

Instructions for the operating system, applications and/or programs may be located in the storage devices 26, which are in communication with the processor unit 14 through the communications bus 12. In these illustrative examples, the instructions are in a functional form on the persistent storage 18. These instructions may be loaded into the memory 16 for execution by the processor unit 14. The processes of the different embodiments may be performed by the processor unit 14 using computer implemented instructions, which may be located in a memory, such as the memory 16. These instructions are referred to as program code 38 (described below) computer usable program code, or computer readable program code that may be read and executed by a processor in the processor unit 14. The program code in the different embodiments may be embodied on different physical or tangible computer readable media, such as the memory 16 or the persistent storage 18.

The DPS 10 may further comprise an interface for a network 29. The interface may include hardware, drivers, software, and the like to allow communications over wired and wireless networks 29 and may implement any number of communication protocols, including those, for example, at various levels of the Open Systems Interconnection (OSI) seven layer model.

FIG. 1A further illustrates a computer program product 30 that may contain the program code 38. The program code 38 may be located in a functional form on the computer readable media 32 that is selectively removable and may be loaded onto or transferred to the DPS 10 for execution by the processor unit 14. The program code 38 and computer readable media 32 may form a computer program product 30 in these examples. In one example, the computer readable media 32 may be computer readable storage media 34 or computer readable signal media 36. Computer readable storage media 34 may include, for example, an optical or magnetic disk that is inserted or placed into a drive or other device that is part of the persistent storage 18 for transfer onto a storage device, such as a hard drive, that is part of the persistent storage 18. The computer readable storage media 34 also may take the form of a persistent storage, such as a hard drive, a thumb drive, or a flash memory, that is connected to the DPS 10. In some instances, the computer readable storage media 34 may not be removable from the DPS 10.

Alternatively, the program code 38 may be transferred to the DPS 10 using the computer readable signal media 36. The computer readable signal media 36 may be, for example, a propagated data signal containing the program code 38. For example, the computer readable signal media 36 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 38 may be downloaded over a network to the persistent storage 18 from another device or DPS through the computer readable signal media 36 for use within the DPS 10. For instance, program code stored in a computer readable storage medium in a server DPS may be downloaded over a network from the server to the DPS 10. The DPS providing the program code 38 may be a server computer, a client computer, or some other device capable of storing and transmitting the program code 38.

The different components illustrated for the DPS 10 are not meant to provide architectural limitations to the manner in which different embodiments may be implemented. The different illustrative embodiments may be implemented in a DPS including components in addition to or in place of those illustrated for the DPS 10.

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1B, illustrative cloud computing environment 52 is depicted. As shown, cloud computing environment 52 includes one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 52 to offer infrastructure, platforms and/or software as services for which a cloud consumer does not need to maintain resources on a local computing device. It is understood that the types of computing devices 54A-N shown in FIG. 1B are intended to be illustrative only and that computing nodes 50 and cloud computing environment 52 can communicate with any type of computerized device over any type of network and/or network addressable connection (e.g., using a web browser).

Referring now to FIG. 1C, a set of functional abstraction layers provided by cloud computing environment 52 (FIG. 1B) is shown. It should be understood in advance that the components, layers, and functions shown in FIG. 1C are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application processing elements 96.

Any of the nodes 50 in the computing environment 52 as well as the computing devices 54A-N may be a DPS 10.

### Computer Readable Media

The present invention may be a system, a method, and/or a computer readable media at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention are presented for purposes of illustration, but are not intended to be exhaustive or limited to the embodiments disclosed. Many modifications and variations will be apparent to those of ordinary skill in the art without departing from the scope and spirit of the described embodiments. The terminology used herein has been chosen to best explain the principles of the embodiments, the practical application or technical improvement over technologies found in the marketplace, or to enable others of ordinary skill in the art to understand the embodiments disclosed herein.

### Protecting Sensitive Data Dump Information

The following application-specific acronyms may be used below:

TABLE 2
Application-Specific Acronyms

| | |
|---|---|
| ACF2 | Access Control Facility 2 |
| CICS ® | Customer Information Control System |
| CPACF ® | CP Assist for Cryptographic Function |
| DB2 ® | Database 2 |
| DF | dump file |
| DFSMS ® | Data Facility Storage Management System |
| EDF | encrypted dump file |
| LAC | logical access control |
| PC | personal computer |
| RACF ® | Resource Access Control Facility |
| SMS | storage management system |
| SPI | security provider interface |

Disclosed herein are a system and method for protecting sensitive user data in a DF to avoid security provider interface (SPI) exposure. Protecting user data in a DF may be provided by a dedicated support environment for a specific customer (such as IBM's Blue Diamond® environment), which uses dump encryption. In this environment, only users with a matching private key may decrypt the DF and perform diagnosis work.

The following process may be used to protect sensitive user data in a DF to avoid SPI exposure. First, the DF may be scanned to identify sensitive data to be protected, based on, e.g., predefined keywords in a list, data following predefined keywords (e.g., numberic/text), positions or offsets within specific data records, etc.. An encryption table may be created to associate user sensitive data in different regions within the DF with different users/roles. This may be done prior to the DF scanning to define particular regions/offsets/data structures, or after the DF scanning to indicated where sensitive data was located by the scan. The regions may be overlapping or not overlapping. Next, the process may build relationships for sensitive data and generate sensitive data with a risk level table. The process may then use a multiplex encryption method to encrypt sensitive data and use a dump format tool to generate an encrypted DF (EDF) from the plain dump file. The EDF may be a fully or a partially encrypted DF. The process may share multiple encrypted keys to different users with different roles and then transfer an encrypted dump to target consumer to decrypt and use. The process may use one or multiple decryption keys to decrypt data and associated data with the same risk level, and may classify different users, regardless of internals or externals, to view the raw data at different encryption levels.

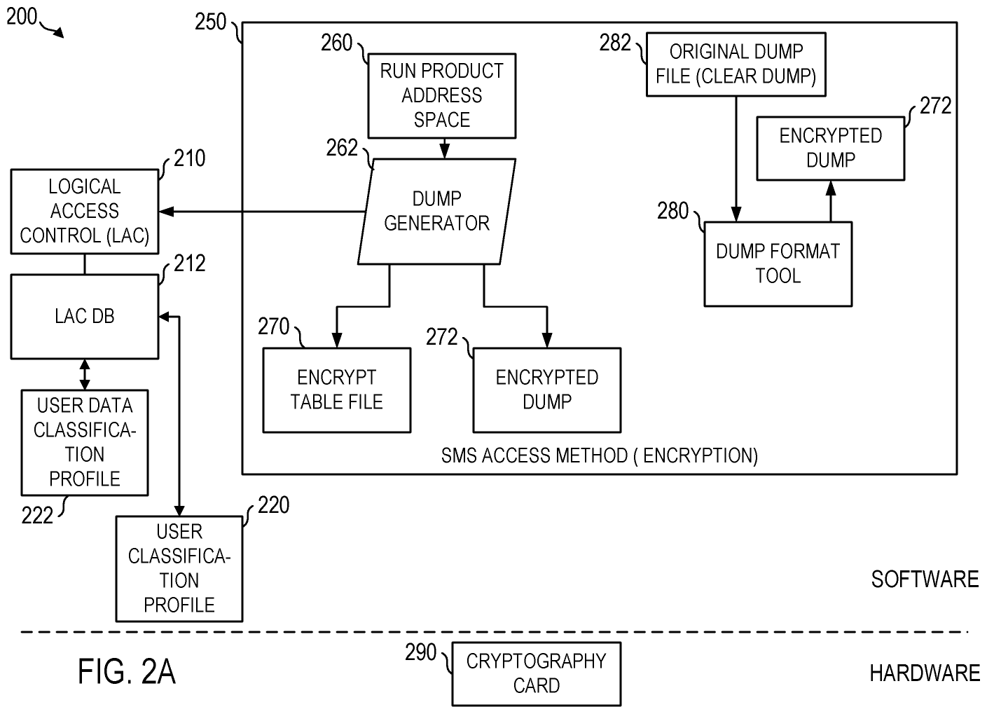

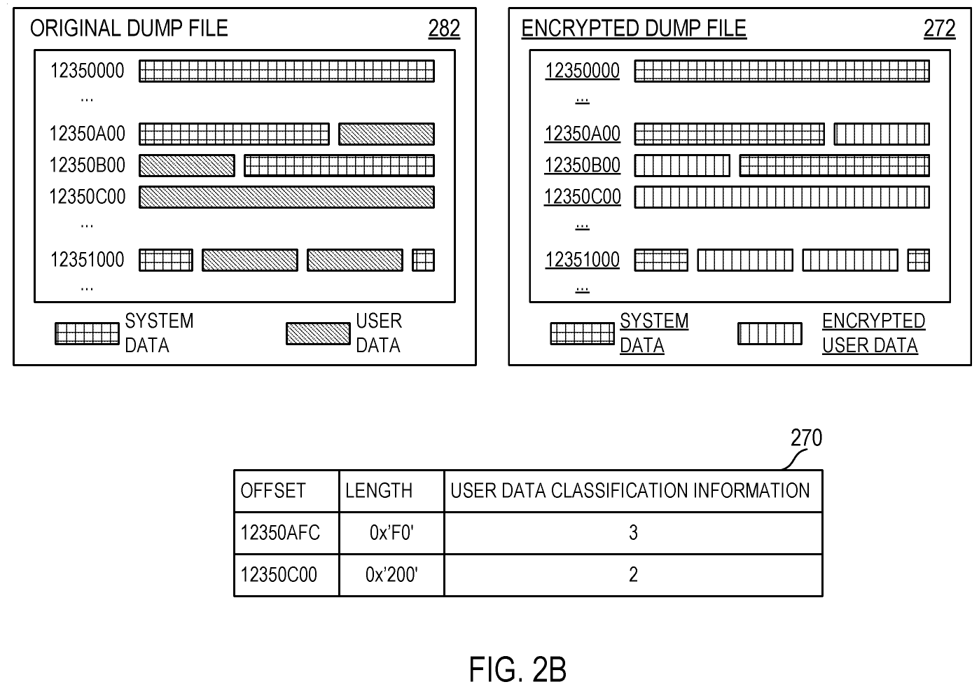

FIG. 2A is a block diagram that illustrates an example of a system 200 for protecting sensitive data dump information, according to various embodiments. The system 200 may comprise one of more DPSs 10, and, in some embodiments, be organized in a cloud computing environment 52 using computing nodes 50 as the DPSs 10, as described above. The functionality of the system 200 described herein may be implemented, e.g., as the application processing elements 96.

As can be seen in FIG. 2A, one or more LACs 210 may interface with a LAC database 212, within which exist a user classification profile 220, and a user data classification profile 222. The LAC 210 receives its dump information from, in some embodiments, a storage management system (SMS) 250 that may use, e.g., pervasive encryption, such as the Data Facility SMS (DFSMS®). Within the SMS 250, a product, application, or any form of software module (“run product” 260) may run in a particular address space. When a dump is triggered, e.g., by something like a data fault, an invalid operation being executed, or some form of abnormal termination, a dump generator 262 may (e.g., with the assistance of a dump format tool 280) generate a clear dump 282 and an encrypted dump 272. The dump generator 262 may further produce an encrypt table file 270. The encrypt table file 270 may include information from (or a link to information from) the user data classification profile 222 so that the segments defined by the offset and length in the encrypt table file 270 may be classified.

The dump generator 262 provides the dump information to the LAC 210 which may be stored in the LAC database 212 and is provided to the user classification profile 220 and the user data classification profile 222 stored therein. The software components discussed above may be run on encryption hardware.

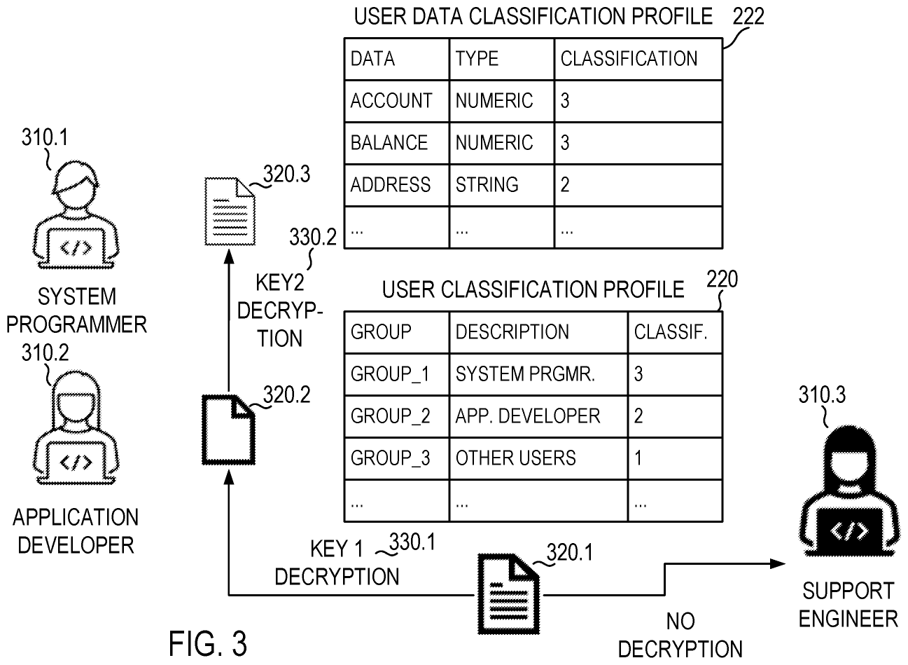

FIG. 2B is a block diagram that illustrates the original DF 282 (also referred to herein as the clear dump file 282), the encrypted DF 272, and the encrypt table file 270 in greater detail, according to some embodiments. As can be seen for both the encrypted DF 272 and the original DF 282, the address space of the DF may be broken down into different regions. The different regions within the encrypted DF 272 may be encrypted differently from one another (i.e., using different encryption keys), or they may remain as clear text. The encrypted DF 272 illustrates only two different data type fields: the system data, and the user data. However, many different data type fields may be present corresponding to different levels of security used for the encrypted DF 272. As shown in the example illustrated by FIG. 3 below, there are three different levels of security corresponding to three different groups in the user classification profile 220, however, there could be any number of security levels, and these possibly, but not necessarily, arranged in a hierarchical format. In one embodiment, a first encrypted region is provided as a proper subset of the DF, where the remaining portion of the DF may be some combination of encrypted and clear text regions.

The encrypt table file 270 delineates the regions by having table records that include the memory address offset and length. For example, one of the regions of user data has a record in the encrypt table file 270 having its offset of 0x12350AFC, and its length, for example, of 0xF0. In another example, one of the regions of user data has an offset of 0x12350000 and a length of 0x200. The encrypt table file 270 may be organized in various ways. For example, the encrypt table file 270 may have multiple tables within it, and each table corresponds to a different group access level. In this case, each table defines the region locations and lengths for each group access level. Alternately, the encrypt table file 270 may have an additional column that identifies a particular security level/group for that particular region. In this way, it can be determined which encryption key (if any) should be used to encrypt the respective data region in the original DF 282 to produce that respective region in the encrypted DF 272, and hence, which decryption key should be used to decrypt the respective data region in the encrypted DF 272. The encryption table file 270 may be used by the security management tools, (e.g., RACF, AC2, etc.) to define a security profile (e.g., the user classification profile 220 and/or the user data classification profile 222) that may be used to control the access to the (ultimately encrypted) DF. The encryption table file 270 may also be used by storage management to perform the hardware encryption (e.g., by a cryptography card 290, such as Crypto Express6S®).

The encryption/decryption keys may be implemented, e.g., using a public key/private key cryptography mechanism. Also, it is possible that the security and the keys provided are such that they are arranged in a hierarchy and each higher security level needs an additional key to encrypt and decrypt the relevant DF region. Alternately, different single keys could be uses to encrypt and decrypt the relevant DF region. The arrangement does not need to follow a hierarchical architecture, and may also use hybrid hierarchical/tree structures in combination.

Once the DF is encrypted into the encrypted DF 272, only users with the right authorization are allowed to view the restricted sections that they are authorized to view. Users on a different site or having a different security classification, such as a support engineer 310.3 belonging to a software support team (as illustrated in FIG. 3, discussed below), will not be able to see the raw user data or at least the raw user data that they are not authorized to view. The user data they are not authorized to view are fully encrypted so that no sensitive user data is exposed to those without authorization.

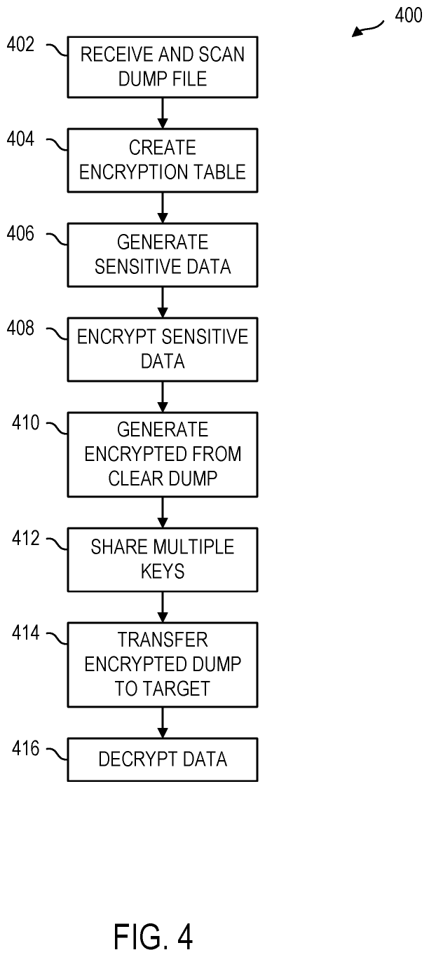

FIG. 3 is a block diagram illustrating an example of the user classification profile 220 and the user data classification profile 222, according to some embodiments. FIG. 4 is a flowchart illustrating a process 400 for protecting sensitive data dump information, according to some embodiments. FIGS. 3 and 4 will be discussed together below. Although various modules shown in FIG. 3 may be indicated as performing the functionality of the operation discussed in the process shown in FIG. 4, the performance of the various functionalities may be performed by any of the modules/entities shown in FIG. 3.

Referring to FIG. 4, process 400 may initially be triggered when a problem occurs or when a dump command is issued in the run product address space 260, according to some embodiments. When a problem occurs or a dump command is issued, the address space 260 becomes frozen for a short time window, which allows the operating system to capture the dump and generate the original DF 262.

As soon as the dump is taken, the first module, the storage analysis model, is driven to call a product related module to analyze the storage allocation and create an encryption table, which contains information that can be used to locate the user application data.

In operation 402, once a DF has been generated, it may be scanned by a scanner of the dump generator 262 to identify sensitive data to be protected. This scanning may be performed by identifying predefined absolute or relative indexes into the DF data according to known data structures, by scanning for key words and/or phrases, looking at various bit patterns, or by using some other technique for delineating the data of the DF into the relevant security regions. In some embodiments, a product-based encrypt table file 270 may be used to identify the sensitive data regions, e.g., by a set of bounded regions in the DF, as illustrated in FIG. 3, and a security classification level may be associated with each of the bounded regions.

In operation 404, the dump generator 262 may create the encryption table file 270 to associate sensitive data within the DF with different users, roles, or security classification levels. For example, FIG. 3 illustrates the following user roles or security classification: a system programmer 310.1, an application developer 310.2, and a support engineer 310.3. The encryption table 270 may associate the users, roles, or security classifications to the sensitive data regions based on analyzed contents of the data and/or where the data is located within the dump.

In operation 406, the dump generator 262 may build a relationship for the sensitive data and generate a descriptive profile to classify sensitive information to determine if multiple encryptions are required for this piece of information. This may be done with a risk level table (the user data classification profile table 222). This operation may identify the various classifications for the data regions identified in the DF (see the user data classification profile 222). In the user data classification profile 222, the different data fields in the dump data may bey provided with a data identifier (e.g., “balance”), a data type (e.g., “numeric value”) and its security classification (e.g., “3”). The classification field here may link to user groups having access to data (and may designate different classifications according to a hierarchy, security level, bit mapping to different groups, etc.) This means that in order to access the information in the encrypted DF 272, a user will have to belong to a group of users who have access to security classification level 3, whereas access to the address information contained therein (of type “string”), the user will only have to belong to a group of users who have access to a lower security classification level 2.

By way of example, in FIG. 3, the user classification profile table 220 shows three different groups, each associated with a different security level classification (the classification field performing a linkage between the user classification profile table 220 and the user data classification profile table 222). The system programmer 310.1, a member of GROUP_1, has access to the highest security level classification, level 3. The application developer 310.2, a member of GROUP_2, has access to a lower security level classification, level 2. The support engineer, a member of GROUP_3, has access to a lowest security level classification, level 1. The defined levels do not have to be strictly hierarchical, meaning that anyone from a higher level can see everything from a lower level. There could be parallel levels in which one person or group has access to a particular region that no one else does, but others may have access to a different region that no one else has. The important aspect is that the end user has access to any necessary decryption keys that are needed to access the data that they are authorized to access, in the encrypted DF 272, presuming it has been encrypted properly, whether in a hierarchical manner or not.

In operation 408, the identified regions of the sensitive data may be encrypted using, e.g., a multiplex encryption method (i.e., an encryption that may be performed multiple times) using an encryption key that is associated with that particular region of the DF. The encryption process is based on the content that is dynamically located through the dump analysis process and the sensitivity level of the content. The decryption process may also have multiple stages, which depends on the user or entity who is formatting the encrypted DF. For example, the “account” region(s) may be encrypted with an encryption key having a security level classification of 3 (meaning that those in GROUP_1, such as the system programmer) will be able to access this “account” region(s). The other identified regions may be similarly encrypted with their respective security level classification encryption keys, or, for the lowest level of security regions, they may be left as plain (clear) text.

In operation 410, the dump format tool 280 may be used to generate the encrypted dump 272 from the original dump file (clear dump) 282 by, for example, assembling all of the encrypted and clear regions from operation 408.

In operation 412, multiple decryption keys may be shared to different users with different roles so that the users can properly decrypt the respective regions of the encrypted DF 272 that they are authorized to have access to. FIG. 3 shows various users, including, by way of example, a system programmer 310.1, an application developer 310.2, and a support engineer 310.3 (collectively or representatively 310). In operation 414, the encrypted DF 320.1 may be transferred to a target consumer of the DF (e.g., the owners or sellers of the software that generated the DF, who may employ the system programmer 310.1, the application developer 310.2, and the support engineer 310.3) to analyze. In this example, the support engineer 310.3 belonging to GROUP_3 has the lowest level of access and receives no decryption keys or has no decryption activities performed on the encrypted DF 320.1 prior to his receipt. The application developer 310.2 belonging to GROUP_2 has a low level of access and either receives the decryption keys permitting decryption of security level classification 2 regions of the encrypted DF 320.1 permitting access to the security level classification 2 encrypted regions, or receives the partially decrypted DF 320.2 in which the security level classification 2 encrypted regions have been already descripted. Similarly, the system programmer 310.1 belonging to GROUP_1 has the highest level of access and either receives the decryption keys permitting decryption of security level classification 3 regions of the encrypted DF 320.1 permitting access to the security level classification 3 encrypted regions, or receives the partially decrypted DF 320.3 in which the security level classification 3 encrypted regions have been already descripted.

In operation 416, as alluded to above, the encrypted regions of the DF are decrypted using the appropriate decryption keys for each group member's security level classification. This may be done prior to the receipt of a partially (or possibly fully, depending on the security level) decrypted DF, or the user may receive the encrypted file and then perform the decryption themselves using the appropriate decryption key (or possible multiple decryption keys) that they have been provided with according to the authorization levels of their associated group.

Advantageously, various embodiments of the system and method described herein may allow for different levels of decryptions of sensitive data for different users and their respective rolls. The various embodiments may provide the confidence needed for a user to share their dump file, knowing that the secure information will remain properly protected, and thereby enhance a collaboration between customers and their service providers.

### Technical Application

The one or more embodiments disclosed herein accordingly provide an improvement to computer technology. For example, an improvement to providing security to application and system log files encourages sharing of such log files between a customer and related developers, even when sensitive information is involved.

### EXAMPLES

The following are examples of various embodiments.
Example 1 is a computer-implemented method for protecting sensitive data dump information, comprising, using a processor:
   receiving a dump file (DF) associated with an application;
   allocating user classification profiles defining security access levels to different regions of the DF;
   encrypting a first encrypted region that is a proper subset of the different regions using a first encryption key associated with a first user classification profile of the user classification profiles to produce an encrypted DF (EDF);
   determining a first user to be a member of the first user classification profile; and
   providing access to the EDF and a first decryption key useable to decrypt the first encrypted region to the first user.
Example 2 is the method of Example 1, further comprising decrypting the first encrypted region using the first decryption key.
Example 3 is the method of Example 1 or Example 2, wherein the EDF further comprises an unencrypted region that is viewable without any decryption key.
Example 4 is the method of one of Examples 1 to 3, further comprising:
   encrypting a second encrypted region that is different from the first encrypted region and is a proper subset of the different regions using a second encryption key associated with a second user classification profile that differs from the first user classification profile of the user classification profiles to produce the encrypted DF (EDF);
   determining a second user to be a member of the second user classification profile;
   providing access to the EDF and a second decryption key useable to decrypt the second encrypted region to the second user.
Example 5 is the method of Example 4, wherein the second encrypted region additionally uses the first encryption key for encryption, and requires the first decryption key for decryption.
Example 6 is the method of one of Examples 1 to 5, further comprising:
   identifying the first encrypted region within the DF by scanning the DF.
Example 7 is the method of one of Examples 1 to 6, further comprising:
   creating an encryption table that associates different DF regions with different users or roles.
Example 8 is the method of one of Examples 1 to 7, wherein:
   the encryption element is an encryption cryptographic key; and
   the decryption element is a decryption cryptographic key associated with the encryption cryptographic key.
Example 9 is the method of Example 8, wherein the encryption and decryption elements use public and private keys.
Example 10 is the method of one of Examples 1 to 9, wherein the encryption element uses a multiplex encryption operation.
Example 11 is the method of one of Examples 1 to 10, wherein the first user classification profile has a plurality of members who are sent the first decryption key.
Example 12 is the method of one of Examples 1 to 11, further comprising defining a user data classification profile that defines the different regions of the DF and their respective security classifications.
Example 13 is the method of Example 12, further comprising using the user data classification profile to define the different regions of the DF.
Example 14 is the method of Examples 12 or 13, further comprising defining the user data classification profile by the scanning of the DF.
Example 15 is a system for protecting sensitive data dump information, comprising:
   a memory; and
   a processor that is configured to:
      receive a dump file (DF) associated with an application;
      allocate user classification profiles defining security access levels to different regions of the DF;
      encrypt a first encrypted region that is a proper subset of the different regions using a first encryption key associated with a first user classification profile of the user classification profiles to produce an encrypted DF (EDF);
      determine a first user to be a member of the first user classification profile; and
      provide access to the EDF and a first decryption key useable to decrypt the first encrypted region to the first user.
Example 16 is the system Example 15, wherein the processor is further configured to:
   encrypt a second encrypted region that is different from the first encrypted region and is a proper subset of the different regions using a second encryption key associated with a second user classification profile that differs from the first user classification profile of the user classification profiles to produce the encrypted DF (EDF);
   determine a second user to be a member of the second user classification profile; and
   provide access to the EDF and a second decryption key useable to decrypt the second encrypted region to the second user.
Example 17 is the system of Example 15 or 16, wherein the second encrypted region additionally uses the first encryption key for encryption, and requires the first decryption key for decryption.
Example 18 is the system of one of Examples 15 to 17, wherein the processor is further configured to:
   create an encryption table that associates different DF regions with different users or roles.
Example 19 is the system of one of Examples 15 to 18, wherein:
   the processor is further configured to define a user data classification profile that defines the different regions of the DF and their respective security classifications;
   the encryption element uses a multiplex encryption operation; and
   the first user classification profile has a plurality of members who are sent the first decryption key.
Example 20 is a computer program product for a system for protecting sensitive data dump information, the computer program product comprising:
   one or more computer readable storage media, and program instructions collectively stored on the one or more computer readable storage media, the program instructions comprising program instructions to:
      receive a dump file (DF) associated with an application;
      allocate user classification profiles defining security access levels to different regions of the DF;
      encrypt a first encrypted region that is a proper subset of the different regions using a first encryption key associated with a first user classification profile of the user classification profiles to produce an encrypted DF (EDF);
      determine a first user to be a member of the first user classification profile; and
      provide access to the EDF and a first decryption key useable to decrypt the first encrypted region to the first user.

What is claimed is:

1. A computer-implemented method for protecting sensitive data dump information, comprising, using a processor:
receiving a dump file (DF) associated with an application;
allocating user classification profiles defining security access levels to different regions of the DF;
encrypting a first encrypted region that is a proper subset of the different regions using a first encryption key associated with a first user classification profile of the user classification profiles to produce an encrypted DF (EDF);
determining a first user to be a member of the first user classification profile; and
providing access to the EDF and a first decryption key useable to decrypt the first encrypted region to the first user.

2. The method of claim 1, further comprising decrypting the first encrypted region using the first decryption key.

3. The method of claim 1, wherein the EDF further comprises an unencrypted region that is viewable without any decryption key.

4. The method of claim 1, further comprising:
encrypting a second encrypted region that is different from the first encrypted region and is a proper subset of the different regions using a second encryption key associated with a second user classification profile that differs from the first user classification profile of the user classification profiles to produce the encrypted DF (EDF);
determining a second user to be a member of the second user classification profile;
providing access to the EDF and a second decryption key useable to decrypt the second encrypted region to the second user.

5. The method of claim 4, wherein the second encrypted region additionally uses the first encryption key for encryption, and requires the first decryption key for decryption.

6. The method of claim 1, further comprising:
identifying the first encrypted region within the DF by scanning the DF.

7. The method of claim 1, further comprising:
creating an encryption table that associates different DF regions with different users or roles.

8. The method of claim 1, wherein:
the encryption element is an encryption cryptographic key; and
the decryption element is a decryption cryptographic key associated with the encryption cryptographic key.

9. The method of claim 8, wherein the encryption and decryption elements use public and private keys.

10. The method of claim 1, wherein the encryption element uses a multiplex encryption operation.

11. The method of claim 1, wherein the first user classification profile has a plurality of members who are sent the first decryption key.

12. The method of claim 1, further comprising defining a user data classification profile that defines the different regions of the DF and their respective security classifications.

13. The method of claim 12, further comprising using the user data classification profile to define the different regions of the DF.

14. The method of claim 12, further comprising defining the user data classification profile by the scanning of the DF.

15. A system for protecting sensitive data dump information, comprising:
a memory; and
a processor that is configured to:
receive a dump file (DF) associated with an application;
allocate user classification profiles defining security access levels to different regions of the DF;
encrypt a first encrypted region that is a proper subset of the different regions using a first encryption key associated with a first user classification profile of the user classification profiles to produce an encrypted DF (EDF);
determine a first user to be a member of the first user classification profile; and
provide access to the EDF and a first decryption key useable to decrypt the first encrypted region to the first user.

16. The system of claim 15, wherein the processor is further configured to:
encrypt a second encrypted region that is different from the first encrypted region and is a proper subset of the different regions using a second encryption key associated with a second user classification profile that differs from the first user classification profile of the user classification profiles to produce the encrypted DF (EDF);
determine a second user to be a member of the second user classification profile; and
provide access to the EDF and a second decryption key useable to decrypt the second encrypted region to the second user.

17. The system of claim 16, wherein the second encrypted region additionally uses the first encryption key for encryption, and requires the first decryption key for decryption.

18. The system of claim 15, wherein the processor is further configured to:
create an encryption table that associates different DF regions with different users or roles.

19. The system of claim 15, wherein:
the processor is further configured to define a user data classification profile that defines the different regions of the DF and their respective security classifications;
the encryption element uses a multiplex encryption operation; and
the first user classification profile has a plurality of members who are sent the first decryption key.

20. A computer program product for a system for protecting sensitive data dump information, the computer program product comprising:
one or more computer readable storage media, and program instructions collectively stored on the one or more computer readable storage media, the program instructions comprising program instructions to:
receive a dump file (DF) associated with an application;
allocate user classification profiles defining security access levels to different regions of the DF;
encrypt a first encrypted region that is a proper subset of the different regions using a first encryption key associated with a first user classification profile of the user classification profiles to produce an encrypted DF (EDF);
determine a first user to be a member of the first user classification profile; and
provide access to the EDF and a first decryption key useable to decrypt the first encrypted region to the first user.
